(19) United States
(12) Patent Application Publication
(10) Pub. No.: US 2025/0044634 A1
(43) Pub. Date: Feb. 6, 2025

(54) DISPLAY DEVICE AND METHOD OF MANUFACTURING DISPLAY DEVICE

(71) Applicant: Japan Display Inc., Tokyo (JP)

(72) Inventors: Yasushi IWAKABE, Tokyo (JP); Koichi IGETA, Tokyo (JP)

(73) Assignee: Japan Display Inc., Tokyo (JP)

(21) Appl. No.: 18/789,986

(22) Filed: Jul. 31, 2024

(30) Foreign Application Priority Data
Aug. 4, 2023 (JP) 2023-127742

(51) Int. Cl. G02F 1/1334; G02F 1/1337; G02F 1/1339

(52) U.S. Cl. CPC G02F 1/1334; G02F 1/133784; G02F 1/1339

(57) ABSTRACT

According to one embodiment, a display device includes a first substrate having a plurality of switching elements, a second substrate disposed to oppose the first substrate, a sealing member disposed between the first substrate and the second substrate, and a polymer dispersed liquid crystal layer containing a polymer and liquid crystal molecules and disposed between the first substrate and the second substrate and in a region surrounded by the sealing member, and the polymer dispersed liquid crystal layer has a nematic-isotropic transition temperature higher than a curing temperature of the sealing member.

### CROSS-REFERENCE TO RELATED APPLICATIONS

This application is based upon and claims the benefit of priority from Japanese Patent Application No. 2023-127742, filed Aug. 4, 2023, the entire contents of which are incorporated herein by reference.

### FIELD

Embodiments described herein relate generally to a display device and a method of manufacturing the display device.

### BACKGROUND

In recent years, display devices employing polymer dispersed liquid crystals which can switch between a scattering state, in which incident light is scattered, and a transmission state, in which incident light is transmitted, have been proposed.

### BRIEF DESCRIPTION OF THE DRAWINGS

FIG. 1 is a plan view schematically showing a configuration of a display device in an embodiment.

FIG. 2 is a plan view schematically showing a configuration of a display area of the display device shown in FIG. 1.

FIG. 3 is a cross-sectional view showing an example of a configuration applicable to a display panel shown in FIG. 1.

FIG. 4 is a cross-sectional view schematically showing a configuration example of the display panel.

FIG. 5 is a plan view showing a display panel in a comparative example 1.

FIG. 6 is a flowchart illustrating steps of manufacturing the display panel in the comparative example 1.

FIG. 7 is a plan view showing a display panel in a comparative example 2.

FIG. 8 is a flowchart illustrating steps of manufacturing the display panel in the comparative example 2.

FIG. 9 is a plan view showing a display panel in a comparative example 3.

FIG. 10 is a flowchart illustrating steps of manufacturing the display panel in the comparative example 3.

FIG. 11 is a flowchart illustrating steps of manufacturing the display panel of the embodiment.

FIG. 12 is a flowchart illustrating steps of manufacturing another configuration example of the display device of the embodiment.

### DETAILED DESCRIPTION

In general, according to one embodiment, a display device comprises
a first substrate including a plurality of switching elements;
a second substrate disposed to oppose the first substrate;
a sealing member disposed between the first substrate and the second substrate; and
a polymer dispersed liquid crystal layer containing a polymer and liquid crystal molecules, and disposed between the first substrate and the second substrate and in a region surrounded by the sealing member, wherein
the polymer dispersed liquid crystal layer has a nematic-isotropic transition temperature higher than a curing temperature of the sealing member.

According to another embodiment, a method of manufacturing a display device, comprises
forming a first substrate by forming a plurality of switching elements on a first base,
forming a sealing member so as to surround a display area including the plurality of switching elements;
dropping a polymer dispersed liquid crystal material containing a liquid crystal material containing liquid crystal molecules and liquid crystal monomers onto a region surrounded by the sealing member;
disposing a second substrate to oppose the first substrate;
curing the sealing member by irradiating ultraviolet light thereon; and
forming a polymer by irradiating ultraviolet light onto the liquid crystal monomers to polymerize; and
curing the sealing member cured by irradiation of the ultraviolet light, by heating the sealing member, wherein
the polymer dispersed liquid crystal material has a nematic-isotropic transition temperature higher than a curing temperature of the sealing member by heating.

According to still another embodiment, a method of manufacturing a display device, comprises
forming a first substrate by forming a plurality of switching elements on a first base,
forming a sealing member so as to surround a display area including the plurality of switching elements;
dropping a polymer dispersed liquid crystal material containing a liquid crystal material containing liquid crystal molecules and liquid crystal monomers onto a region surrounded by the sealing member;
disposing a second substrate to oppose the first substrate;
curing the sealing member by heating the sealing member;
forming a polymer by irradiating ultraviolet light onto the liquid crystal monomers to polymerize; and
curing the sealing member cured by the heating by irradiation ultraviolet light thereon, wherein
the polymer dispersed liquid crystal material has a nematic-isotropic transition temperature higher than a curing temperature of the sealing member by heating.

An object of this embodiment is to provide a display device in which non-uniformity in display is not created, thereby improving display quality.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment

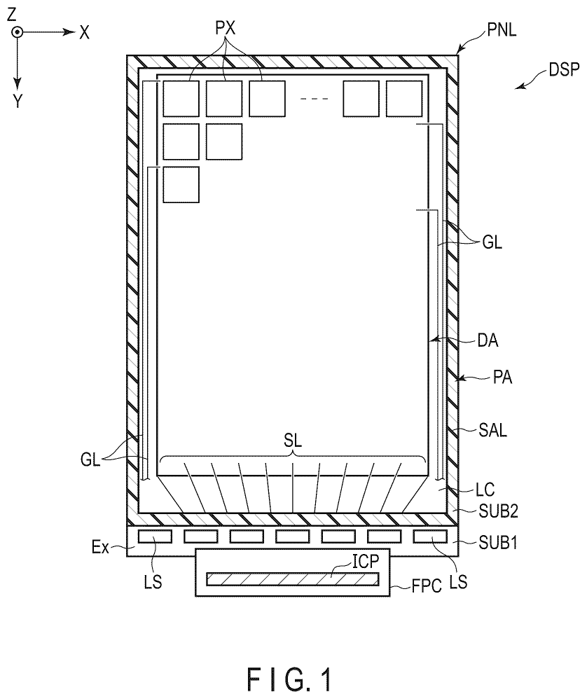

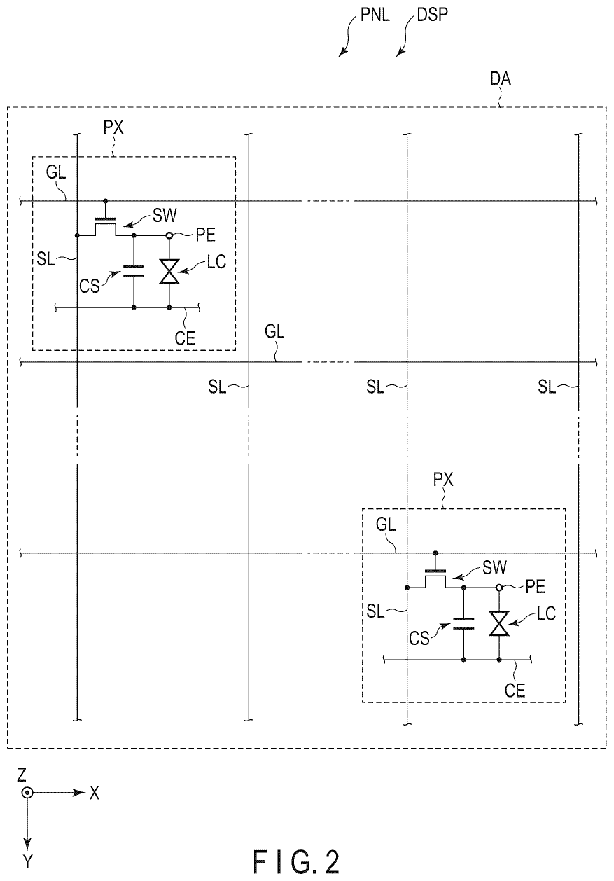

FIG. 1 is a plan view schematically showing a configuration of a display device of an embodiment. FIG. 2 is a plan view schematically showing a configuration of a display area of the display device shown in FIG. 1. In this embodiment, the first direction X and the second direction Y correspond to directions parallel to the main surface of the substrate that constitutes the display device DSP.

In this embodiment, a liquid crystal display device to which polymer dispersed liquid crystal (PDLC) is applied is disclosed as the display device DSP. The display device DSP comprises a display panel PNL, a wiring substrate FPC, an IC chip ICP (drive circuit), and a plurality of light sources LS.

The display panel PNL comprises a substrate SUB1 (array substrate), a substrate SUB2 (counter-substrate), a liquid crystal layer LC, and a sealing member SAL. The substrate SUB1 and substrate SUB2 are formed as flat plates parallel to the X-Y plane and oppose each other along the third direction Z. The liquid crystal layer LC is disposed between the substrate SUB1 and substrate SUB2.

The display panel PNL includes a display area DA which displays images and a frame-like peripheral area PA surrounding the display area DA. The sealing member SAL is provided to surround the display area DA. The display area DA comprises a plurality of pixels PX arranged in a matrix along the first direction X and the second direction Y.

As will be described in detail later, for the sealing member SAL, a mixture of a photocurable resin and thermosetting resin, that is cured, is used. As the photocurable resin, for example, acrylic resin is used. As the thermosetting resin, for example, epoxy resin is used. The acrylic resin is cured by ultraviolet (UV) light, and the epoxy resin is cured by heat.

In the display area DA, a plurality of scanning lines GL are provided, which extend along the first direction X and disposed to be aligned along the second direction Y. Further, a plurality of signal lines SL are provided to be aligned along the first direction X and extend along the second direction Y. At the intersections of the plurality of scanning lines GL and the plurality of signal lines SL, pixels PX are respectively provided. Each one pixel PX is disposed in a region surrounded by each adjacent pair of scanning lines GL and each respective adjacent pair of signal lines SL.

The plurality of pixels PX each comprise a switching element SW, a pixel electrode PE, and a common electrode CE. The switching element SW is constituted by a thin-film transistor (TFT), for example, and is electrically connected to one scanning line GL and one signal line SL. One scanning line is electrically connected to the switching element SW in each of the plurality of pixels PX aligned along the second direction Y. One signal line SL is electrically connected to the switching element SW in each of the plurality of pixels PX aligned along the second direction Y.

The pixel electrode PE is electrically connected to the switching element SW. The common electrode CE is commonly provided for a plurality of pixel electrodes PE. The liquid crystal layer LC is driven by the electric field generated between the pixel electrodes PE and the common electrode CE. For example, between an electrode having the same potential as that of the common electrode CE and an electrode having the same potential as that of the pixel electrode PE, a capacitor CS is formed.

The scanning lines GL, signal lines SL, switching elements SW, and pixel electrodes PE are provided on the substrate SUB1, and the common electrode CE is provided on the substrate SUB2. The scanning lines GL extend out to the peripheral area PA and are electrically connected to the wiring board FPC or the IC chip ICP. The signal lines SL extend out to the peripheral area PA and are electrically connected to the wiring board FPC or the IC chip ICP.

The wiring board FPC is electrically connected to a terminal located in an extended portion Ex of the substrate SUB1. The extended portion Ex corresponds to a portion of the substrate SUB1, which does not oppose the substrate SUB2. For example, the wiring substrate FPC is a flexible printed circuit board. The IC chip ICP is mounted on the wiring substrate FPC. The IC chip ICP contains, for example, a display driver built therein, that outputs signals necessary for image display. Note that the IC chip ICP may be mounted on the extended portion Ex.

The plurality of light sources LS are provided to overlap the extended portion Ex. These light sources LS are arranged to be spaced apart from each other along the first direction X. Each of the plurality of light sources LS contains, for example, a light emitting element that emits red (R) light, a light emitting element that emits green (G) light, and a light emitting element that emits blue (B) light. For these light emitting elements, for example, light-emitting diodes (LEDs) can be employed, but are not limited to those of this example.

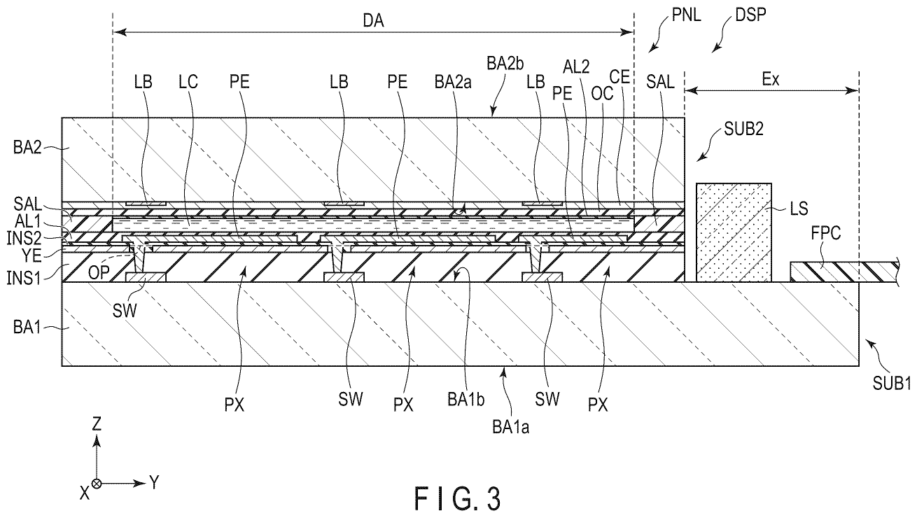

FIG. 3 is a cross-sectional view of an example of a configuration that can be applied to the display panel shown in FIG. 1. The substrate SUB1 comprises a base BA1, an insulating layer INS1, an insulating layer INS2, a capacitive electrode YE, an alignment film AL1, a switching element SW, and a pixel electrode PE. The base BA1 has a surface BA1a and a surface BA1b located on an opposite side to the surface BA1a along the third direction Z. The surface BA1a and surface BA1b may as well be referred to as a lower surface and an upper surface of the base BA1, respectively.

The switching element SW is disposed on a surface BA1b side. The insulating layer INS1 covers the switching element SW. Although the switching element SW is illustrated in a simplified manner in FIG. 3, the switching element SW actually contains a semiconductor layer and various types of electrodes. Further, the scanning lines GL and signal lines SL shown in FIG. 1 are located between the base BA1 and the insulating layer INS1, but they are omitted from the illustration in FIG. 3.

The capacitive electrode YE is disposed between the insulating layer INS1 and the insulating layer INS2. The pixel electrode PE is disposed between the insulating layer INS2 and the alignment film AL1 for each pixel PX. The pixel electrode PE is electrically connected to the switching element SW via an aperture OP of the capacitive electrode YE. The pixel electrode PE is provided to oppose the capacitive electrode YE, thus forming the capacitor CS described above. The alignment film AL1 covers the pixel electrode PE.

The substrate SUB2 comprises a base BA2, a light-shielding layer LB, an overcoat layer (insulating layer) OC, an alignment film AL2, and a common electrode CE. The base BA2 includes a surface BA2a opposing the substrate SUB1 and a surface BA2b located on an opposite side to the surface BA2a along the third direction Z. The surface BA2a and surface BA2b may as well be referred to as a lower surface and an upper surface of the base BA2, respectively.

In this disclosure, the base BA1 and base BA2 may as well be referred to as a first base and a second base, respectively. Further, the alignment film AL1 and alignment film AL2 may as well be referred to as a first alignment film and a second alignment film, respectively.

The light-shielding layer LB and the common electrode CE are located on a base BA2a side. For example, the light-shielding layer LB is provided to oppose the respective switching element SW, the respective scanning line GL, and the respective signal line SL. The common electrode CE is disposed over a plurality of pixels PX so as to oppose the plurality of pixel electrodes PE along the third direction Z. Further, the common electrode CE covers the light-shielding layer LB. The common electrode CE is at the same potential as that of the capacitive electrode YE. The overcoat layer OC covers the common electrode CE. The alignment film AL2 covers the overcoat layer OC. The liquid crystal layer LC is disposed between the alignment film AL1 and alignment film AL2 and is in contact with the alignment film AL1 and alignment film AL2. Note that the overcoat layer OC may not be provided, but the alignment film AL2 may cover the common electrode CE.

As described above, in the extended portion Ex on the substrate SUB1 (on the base BA1), the light sources LS and the wiring substrate FPC are provided. Note that the light sources LS may not be provided in the extended portion Ex. The light sources LS may be disposed on an outer side the display panel PNL and on an opposite side to the extended portion Ex along a direction opposite to the second direction Y.

The base BA1 and base BA2 are, for example, each a transparent insulating base, such as glass or plastic substrate. The insulating layer INS1 is formed, for example, from a transparent insulating material such as silicon oxide, silicon nitride, silicon oxynitride or acrylic resin. For example, the insulating layer INS1 includes an inorganic insulating film and an organic insulating film. The insulating layer INS2 is, for example, an inorganic insulating film such as of silicon nitride. The capacitive electrode YE, the pixel electrode PE, and the common electrode CE are transparent electrodes each formed from a transparent conductive material, such as indium tin oxide (ITO) or indium zinc oxide (IZO).

Note that the configuration of the display panel PNL is not limited to that discussed in the example shown in FIGS. 1 and 2. For example, the substrate SUB1 may not have a capacitive electrode YE. Further, the substrate SUB2 may not have a light-shielding layer LB.

Moreover, the display device DSP does not comprise polarizers. More specifically, no polarizer is provided on the surface BA1a of the substrate SUB1 of the display panel PNL, and no polarizer is provided on the surface BA2b of the substrate SUB2.

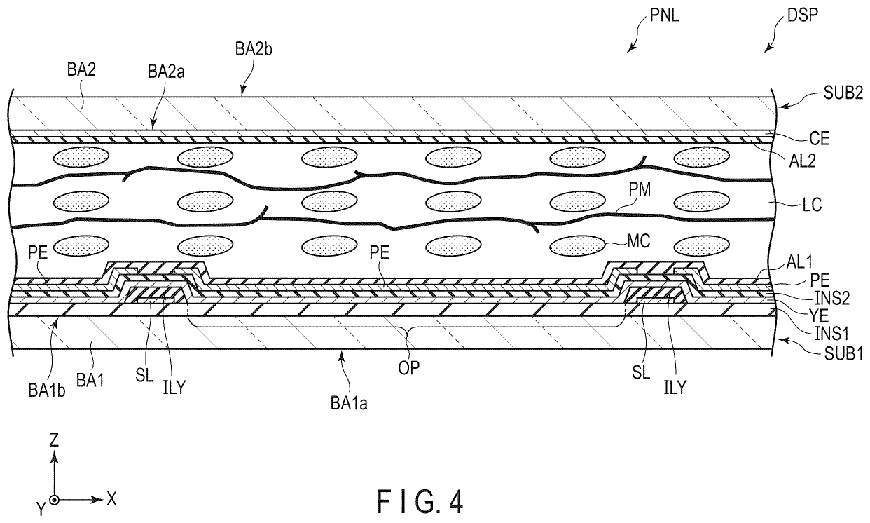

FIG. 4 is a cross-sectional view schematically showing an example of a configuration of the display panel. The display panel PNL comprises a liquid crystal layer LC between the substrate SUB1 and the substrate SUB2. In this embodiment, the liquid crystal layer LC contains a polymer PM containing polymer chains and liquid crystal molecules MC. The liquid crystal molecules MC are dispersed in gaps in the polymer PM.

The substrate SUB1 comprises a base BA1, an insulating layer INS1, signal lines SL, an insulating layer INS2, a capacitive electrode YE, pixel electrodes PE and an alignment film AL1.

The insulating layer INS1 is provided on the surface BA1b of the base BA1. The signal lines SL are provided on the insulating layer INS1 and covered by the insulating layer ILY. The capacitive electrode YE is provided on the insulating layer INS1 in the aperture OP and covered by the insulating layer INS2. The capacitive electrode YE overlaps the insulating layer ILY and opposes the signal lines SL.

The pixel electrode PE is provided on the insulating layer INS2 in the aperture OP and covered by the alignment film AL1. That is, the capacitive electrode YE is provided between the base BA1 and the pixel electrode PE. The pixel electrode PE opposes the capacitive electrode YE while interposing the insulating layer INS2 therebetween to form the capacitor CS of the respective pixel PX. The alignment film AL1 is in contact with the liquid crystal layer LC.

The substrate SUB2 comprises a base BA2, a common electrode CE, and an alignment film AL2. As in the case shown in FIG. 3, an overcoat layer may be provided between the common electrode CE and the alignment film AL2. The common electrode CE is provided in contact with the surface BA2a of the base BA2 and is covered by the alignment film AL2.

Note that in the substrate SUB2, a light-shielding layer may be provided directly above each of the respective switching element SW, the respective scanning line GL, and the respective signal line SL. Further, between the base BA2 and the common electrode CE, a transparent insulating layer (overcoat layer) may be provided. The common electrode CE opposes a plurality of pixel electrodes PE. Further, the common electrode CE is electrically connected to the capacitive electrode YE and is at the same potential as that of the capacitive electrode YE. The alignment film AL2 is in contact with the liquid crystal layer LC.

The polymer PM and the liquid crystal molecules MC have an optical anisotropy or refractive index anisotropy. The responsivity of the polymer PM to an electric field is lower than that of the liquid crystal molecules MC to the electric field. For example, the alignment direction of the polymer PM does not substantially change regardless of the electric field between the pixel electrode PE and the common electrode CE. On the other hand, the alignment direction of the liquid crystal molecules MC changes according to the electric field.

When there is no electric field acting on the liquid crystal layer LC or the electric field is in an extremely weak state, the respective optical axes of the polymer PM and the liquid crystal molecules MC become approximately parallel to each other. Accordingly, the refractive indices of the liquid crystal molecules MC and the polymer PM become substantially equal to each other. In other words, the difference in refractive index between the liquid crystal molecules MC and the polymer PM practically vanishes. Therefore, the light entering the liquid crystal layer LC is transmitted therethrough without being substantially scattered within the liquid crystal layer LC. Hereinafter, such a state is referred to as a transparent state. Further, the voltage at the pixel electrode PE to achieve the transparent state is referred to as a transparent voltage. The transparent voltage may be the same as the common voltage applied to the common electrode CE, or it may be slightly different from the common voltage.

On the other hand, when a sufficient electric field is acting on the liquid crystal layer LC, the respective optical axes of the polymer PM and liquid crystal molecules MC cross each other. As a result, the entering the liquid crystal layer LC is scattered within the liquid crystal layer LC. Hereinafter, such a state is referred to as a scattering state. The voltage at the pixel electrode PE to realize the scattering state is referred to as a scattering voltage. The scattering voltage is a voltage such that the potential difference with the common electrode CE is greater than the transparent voltage.

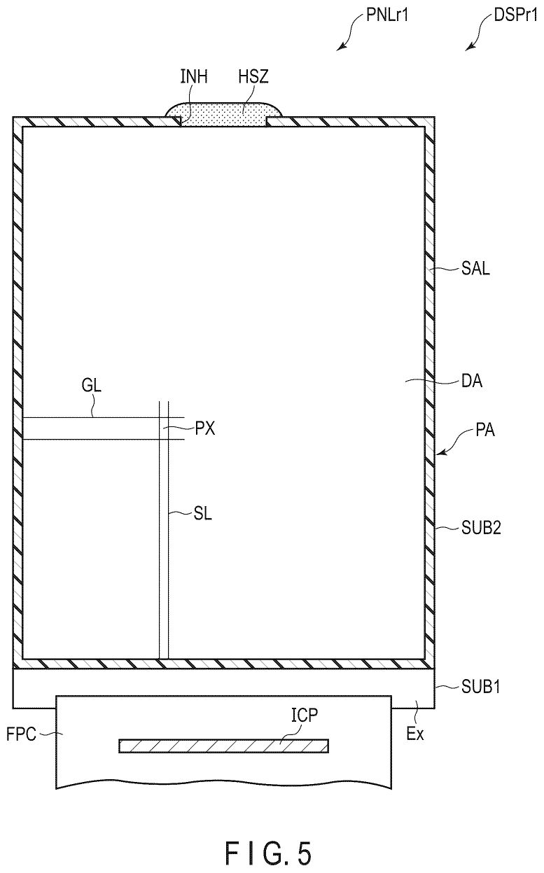

Here, a comparative example will be described. FIG. 5 is a plan view of the display panel of a comparative example 1. In the display panel PNLr1 (display device DSPr1) shown in FIG. 5, for example, a nematic liquid crystal material is used as the liquid crystal layer, in place of the polymer dispersed liquid crystal material. As to the display panel PNLr1 shown in FIG. 5, the same structural elements as those of the display panel PNL shown in FIG. 1 are denoted by the same reference numerals.

In the sealing member SAL of the display panel PNLr1, there is a notch formed, and an injection hole INH is formed in this portion. After the liquid crystal material is suctioned into the display panel PNLr1 by vacuum suction, the injection hole INH is sealed by a sealing member HSZ.

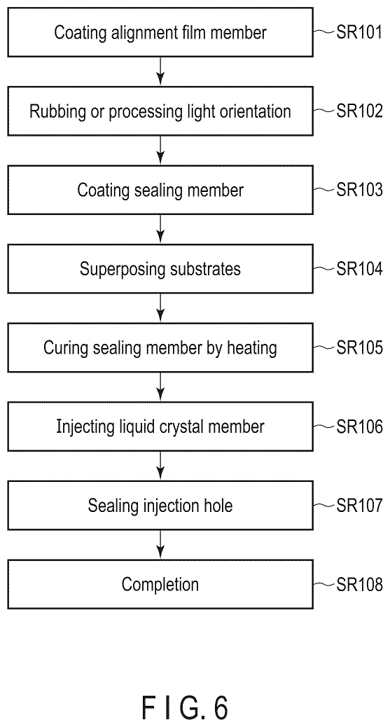

FIG. 6 is a flowchart illustrating a process of manufacturing the display panel in the comparative example 1. With reference to FIG. 6, the injection of the liquid crystal material, in particular, will be explained.

After forming the scanning lines GL, switching elements, signal lines SL, pixel electrodes, planarization insulating layer, and the like on the substrate SUB1 of the display panel PNLr1, an alignment film member is applied (Step SR101: Coating an alignment film member). For example, polyimide resin is used as the alignment film member.

Then, the alignment film member is subject to rubbing or processing light orientation (Step SR102: Rubbing or processing light orientation). Thus, the alignment film is formed.

Subsequently, the sealing member SAL is applied on the substrate SUB1 so as to surround the display area DA (Step SR103: Coating of a sealing member). A thermosetting resin, for example, epoxy resin, is used for the sealing member SAL. In the sealing member SAL, a notch is made as described above.

The substrate SUB2 is superposed on the substrate SUB1 (Step SR104: Superposing the substrates). In the area surrounded by the sealing member SAL (display area DA), a space is created between the substrate SUB1 and the substrate SUB2.

The sealing member SAL is cured by heating (Step SR105: Curing the sealing member by heating). The above-described notch gives rise to the injection hole INH.

The display panel PNLr1 is placed in a vacuum chamber, and the liquid crystal material is injected into the above-described space (in the display area DA) from the injection hole INH by the vacuum sealing method (Step SR106: Injecting the liquid crystal member).

After injecting the liquid crystal material, the injection hole INH is sealed by the sealing member HSZ (Step SR107: Sealing the injection hole). Thus, the display panel PNLr1 is completed (Step SR108: Completion).

In the vacuum sealing method, the sealing member SAL is brought into contact with the liquid crystal material after the sealing member SAL is completely cured. With this configuration, such an advantageous effect can be obtained that the problem of contamination to the liquid crystal material is less. However, the liquid crystal material is injected into the vacuumed display panel PNLr1 by capillary action, the injection time of the liquid crystal material increases, which may deteriorate the productivity as the sizes of the substrate SUB1 and the substrate SUB2 increase.

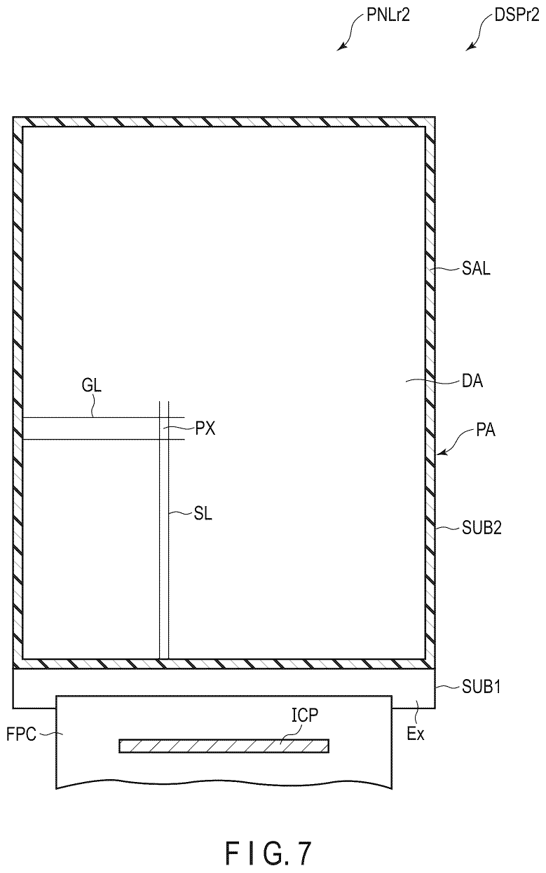

FIG. 7 is a plan view of the display panel of a comparative example 2. In the display panel PNLr2 (display device DSPr2) shown in FIG. 7, for example, a nematic liquid crystal material is used as the liquid crystal layer, in place of the polymer dispersed liquid crystal material. In the display panel PNLr2 shown in FIG. 7, the same components as those of the display panel PNL shown in FIG. 1 are denoted by the same reference numerals.

In the display panel PNLr2, the sealing member SAL is provided to surround the display area DA without any gap. That is, there is no notch made in the sealing member SAL of the display panel PNLr2.

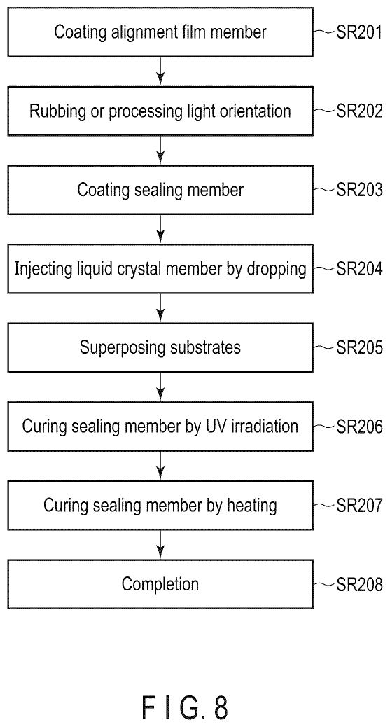

FIG. 8 is a flowchart illustrating a process of manufacturing the display panel in the comparative example 2. With reference to FIG. 8, the dropping of the liquid crystal material, in particular, will be explained.

First, as in the case of step SR101, the alignment film member is applied (Step SR201: Coating of the alignment film member).

Then, as in the case of step SR102, the alignment film member is subjected to rubbing or light orientation process (Step SR202: Rubbing or processing the light orientation). Thus, the alignment film is formed.

A sealing member SAL is applied onto the substrate SUB1 so as to surround the display area DA without any gap (Step SR203: Coating of a sealing member). For the sealing member SAL, a photocurable resin and a thermosetting resin are used. For the photocurable resin, for example, acrylic resin can be used. For the thermosetting resin, for example, epoxy resin may be used. Unlike the display panel PNLr1, a notch is not made in the sealing member SAL of the display panel PNLr2.

After that, the liquid crystal material is injected by dropping into the region surrounded by the sealing member SAL (display area DA) of the substrate SUB1 (Step SR204: Injecting the liquid crystal member by dropping). That is, the liquid crystal material is filled by the one drop fill (ODF) method.

The substrates SUB2 is superposed on the substrate SUB1 (Step SR205: Superposing the substrates). The region (display area DA) between the substrate SUB1 and the substrate SUB2 and surrounded by the sealing member SAL is filled with the liquid crystal material.

Then, the sealing member SAL is cured by UV irradiation (Step SR206: Curing the sealing member by UV irradiation). Thus, the photocurable resin contained in the sealing member SAL is cured.

The sealing member SAL is cured by heating (Step SR207: Curing the sealing member by heating). Thus, the thermosetting resin contained in the sealing member SAL is cured.

As described above, the display panel PNLr2 is completed (Step SR208: Completion).

The liquid crystal dropping (ODF) method does not require a long time to inject the liquid crystal material unlike the vacuum injection method. Therefore, the liquid crystal drop (ODF) method is superior to the vacuum infusion method in terms of productivity. Further, by the liquid crystal drop (ODF) method, the liquid crystal material is not allowed to penetrate to the outside of the sealing member SAL.

However, the sealing member SAL is brought into contact with the liquid crystal material in an uncured state, and therefore there is a risk of contaminating the liquid crystal material and the alignment film.

As mentioned above, the sealing member SAL used in the liquid crystal dropping (ODF) method is generally constituted by a photocurable resin such as acrylic resin and a thermosetting resin such as epoxy resin. Even if UV irradiation is applied to the photocurable resin of the sealing member SAL used in the liquid crystal drop (ODF) method, contamination to the liquid crystal material is very low because the temperature as well is low.

On the other hand, the thermosetting temperature of the sealing member SAL used in the liquid crystal drop (ODF) method is about 120° C. The thermosetting temperature of the sealing member SAL is higher than the nematic-isotropic (nematic-isotropic phase) transition temperature of the liquid crystal material (which is defined as a transition temperature Tni). When the liquid crystal material is heated at a temperature higher than the transition temperature Tni in the process of thermosetting the sealing member SAL (step SR207), the liquid crystal material undergoes a phase transition from the nematic phase to an isotropic liquid of high fluidity. Therefore, the liquid crystal material is more easily contaminated.

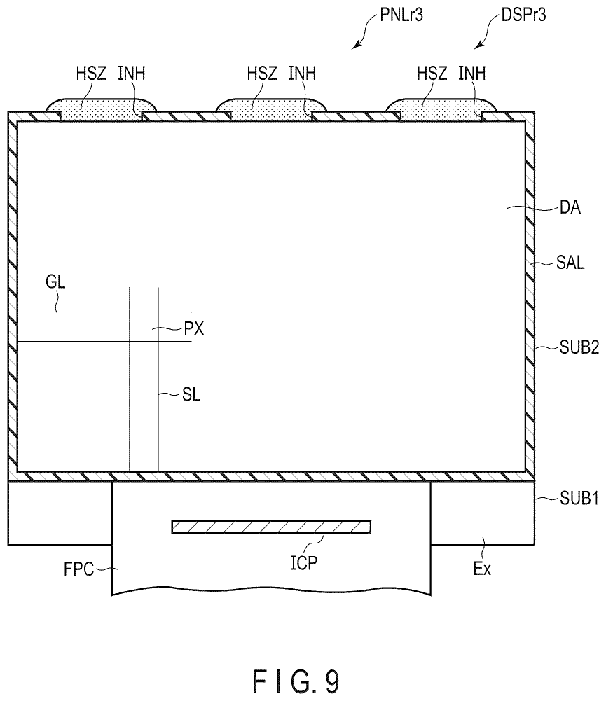

FIG. 9 is a plan view of the display panel of a comparative example 3. In the display panel PNLr3 (display device DSPr3) shown in FIG. 9, polymer dispersed liquid crystal material is used as the liquid crystal layer. For the display panel PNLr3 shown in FIG. 9, the same components as those of the display panel PNL shown in FIG. 1 are denoted by the same reference numerals.

In the sealing member SAL of the display panel PNLr3, a plurality of injection holes INH are formed. After the liquid crystal material is suctioned into the display panel PNLr3 by vacuum suction, each of the injection holes INH is sealed by a respective sealing member HSZ.

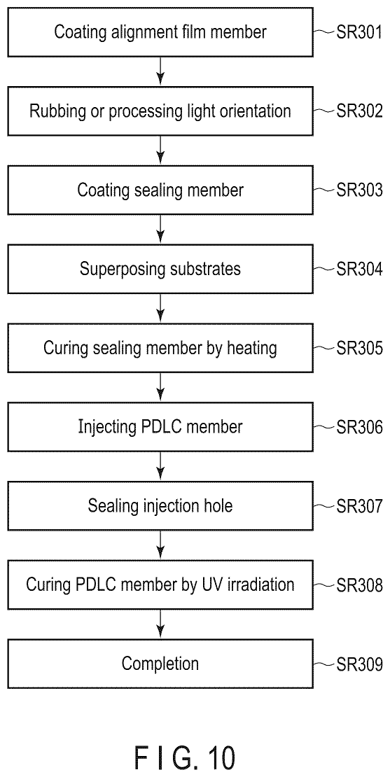

FIG. 10 is a flowchart illustrating the process of manufacturing the display panel in the comparative example 3. With reference to FIG. 10, the injection of the liquid crystal material, in particular, will be explained.

As in the case of step SR101, an alignment film member is applied (Step SR301: Coating of the alignment film member).

Further, as in the case of step SR102, the alignment film member is subjected to rubbing or light orientation processing (Step SR302: Rubbing or processing the light orientation). Thus, the alignment film member is formed.

A sealing member SAL is applied on the substrate SUB1 to surround the display area DA (Step SR303: Coating of the sealing member). For the sealing member SAL, a thermosetting resin is used. As the thermosetting resin, for example, epoxy resin is used. In the sealing member SAL, a plurality of notches are formed as described above.

The substrate SUB2 is superposed on the substrate SUB1 (Step SR304: Superposing the substrates). Between the substrate SUB1 and substrate SUB2 and within the area surrounded by the sealing member SAL (display area DA), a space is formed.

The thermosetting resin of the sealing member SAL is cured by heating (step SR305: Curing the sealing member by heating). The plurality of notches above-described give rise to a plurality of injection holes INH.

Then, the display panel PNLr3 is placed in a vacuum chamber, and a polymer dispersed liquid crystal (PDLC) member is injected into the above-described space (display area DA) from the plurality of injection holes INH by the vacuum sealing method (Step SR306: Injecting the PDLC member).

The polymer dispersed liquid crystal (PDLC) member contains a liquid crystal material containing liquid crystal molecules MC, liquid crystal monomers, a photo-radical polymerization initiator and the like.

After the liquid crystal material is injected, the injection holes INH are sealed by sealing members HSZ (Step SR307: Sealing the injection holes).

Next, the PDLC member is cured by UV irradiation (Step SR308: Curing the PDLC member by UV irradiation).

When the PDLC member is irradiated with ultraviolet (UV) light, polymerization is initiated by the photo-radical polymerization initiator, and the liquid crystalline monomers are polymerized. Thus, the polymer PM containing polymer chains is formed. The liquid crystal molecules MC of the liquid crystal material contained in the polymer dispersed liquid crystal (PDLC) member are dispersed in the gaps of the polymer PM, as described with reference to FIG. 4.

Thus, the display panel PNLr3 is completed (Step SR309: Completion).

As described above, in the vacuum injection method, as the sizes of substrate SUB1 and the substrate SUB2 increase, the injection time of the liquid crystal material increases, which may cause poor productivity. As a measure to this, in this embodiment, the liquid crystal drop (ODF) method is used in the manufacture of display panels containing a polymer dispersed liquid crystal member as the liquid crystal layer LC. With this configuration, it is possible to improve the productivity of the display device.

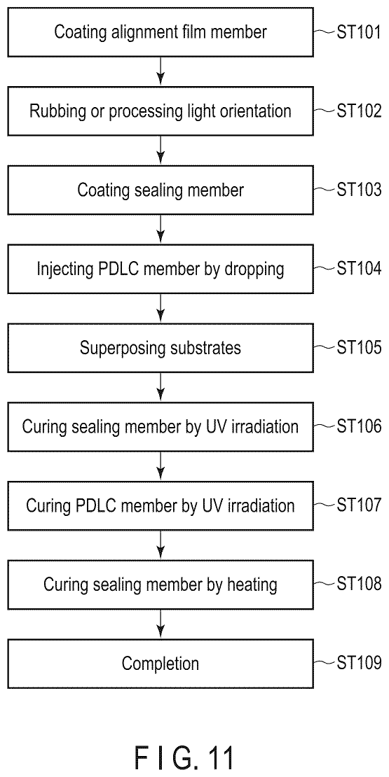

FIG. 11 is a flowchart illustrating a process of manufacturing the display panel of the embodiment. In FIG. 11, the liquid crystal drop (ODF) method, in particular, will be described. The display panel manufactured according to the flowchart shown in FIG. 11 is the display panel PNL (display device DSP) shown in FIG. 1.

As in the case of step SR101, an alignment film member is applied (Step ST101: Coating of the alignment film member).

Then, as in the case of step SR102, the alignment film member is subjected to rubbing or a light orientation processing (Step ST102: Rubbing or processing light orientation). Thus, the alignment film is formed.

Subsequently, a sealing member SAL is applied to the substrate SUB1, so as to surround the display area DA without any gap (Step ST103: Coating of the sealing member). For the sealing member SAL, a photocurable resin and a thermosetting resin are used. For the photocurable resin, for example, acrylic resin can be used. For the thermosetting resin, for example, epoxy resin can be used. As described above, the display area DA is surrounded by the sealing member SAL without any gaps, and there are no notches made therein.

A polymer dispersed liquid crystal (PDLC) member is injected by dropping into the area surrounded by the sealing member SAL (display area DA) of the substrate SUB1 (Step ST104: Injecting the liquid crystal member by dropping). In other words, the polymer dispersed liquid crystal (PDLC) member is filled therein by the ODF method.

The polymer dispersed liquid crystal (PDLC) member contains a liquid crystal material containing liquid crystal molecules MC, liquid crystalline monomers, a photo-radical polymerization initiators and the like.

The substrate SUB2 is superposed on the substrate SUB1 (Step ST105: Superposing the substrates). Between the substrate SUB1 and substrate SUB2 and within the area surrounded by the sealing member SAL (display area DA), the polymer dispersed liquid crystal (PDLC) member is filled.

The thermosetting resin of the sealing member SAL is cured by UV radiation (step ST106: Curing the sealing member by UV radiation). Thus, the thermosetting resin contained in the sealing member SAL is cured.

Next, the polymer dispersed liquid crystal (PDLC) member is cured by UV irradiation (Step ST107: Curing the PDLC member by UV irradiation).

When ultraviolet (UV) light is irradiated, polymerization is initiated by the photo-radical polymerization initiator, and the liquid crystalline monomers are polymerized. Thus, the polymer PM containing polymer chains is formed. The liquid crystal molecules MC of the liquid crystal material contained in the polymer dispersed liquid crystal (PDLC) member are dispersed in the gaps of the polymer PM, as explained with reference to FIG. 4.

Subsequently, the thermosetting resin of the sealing member SAL is cured by heat (Step ST108: Curing the sealing member by heating). Thus, the thermosetting resin contained in the sealing member SAL is cured. Here, the heating temperature in step ST108 is defined as a temperature Tc. By heating the seal material SAL at the temperature Tc, the seal material SAL is cured. Therefore, the temperature Tc may as well be referred to as a curing temperature of the sealing member SAL. Note that the temperature Tc is lower than the transition temperature Tni.

Thus, the display panel PNL (display device DSP) is completed (Step ST109: Completion).

As shown in FIG. 11, after the polymer dispersed liquid crystal (PDLC) member is injected by dropping (Step ST107), the seal material SAL is cured by UV (Step ST108). At this time, the polymer dispersed liquid crystal (PDLC) member located near the seal material SAL, as well, is exposed to ultraviolet (UV) light. Therefore, there is a risk that liquid crystalline monomers contained in the polymer dispersed liquid crystal (PDLC) member are polymerized, and as a result, the areas exposed to the UV light may exhibit abnormal display. In order to avoid this, after the polymer dispersed liquid crystal (PDLC) member is injected by dropping, the sealing member SAL is thermally cured (Step ST108).

The polymer dispersed liquid crystal (PDLC) member of this embodiment is a polymer dispersed liquid crystal (PDLC) member that contains a liquid crystal material having a transition temperature Tni higher than or equal to the temperature Tc at which the seal material SAL is heated in step ST108. More specifically, in this embodiment, a polymer dispersed liquid crystal (PDLC) member containing a liquid crystal material having a transition temperature Tni of 120° C. or higher and 150° C. or lower is used. When the transition temperature Tni is higher than the temperature Tc, which is the heating temperature of the sealing member SAL, the liquid crystal material containing the liquid crystal molecules MC is not converted to an isotropic liquid but remains in the nematic phase during the heating process in step ST108. With this configuration, non-uniformity in display does not occur on the display panel PNL (display device DSP).

When the heating temperature of the thermosetting of the sealing member SAL (step ST108) is higher than the transition temperature Tni of the liquid crystal material, the liquid crystal material undergoes a phase transition from the nematic phase to an isotropic liquid having high fluidity. As a result, the liquid crystal material becomes more easily contaminated and non-uniformity in display is more likely to occur.

The liquid crystal material having a transition temperature Tni of 120° C. or higher and 150° C. or lower is, for example, a liquid crystal material of a high molecular weight. More specifically, the liquid crystal material should be of a type having a large proportion of a tricyclic compound containing three six-membered rings of cyclohexane or benzene ring, or a tetracyclic compound containing four six-membered rings thereof. Further, note here, as to the liquid crystal material, that the proportion of liquid crystal materials having a tricyclic compound or a tetracyclic compound may be larger than the proportion of liquid crystal materials having a bicyclic compound containing two six-membered rings.

Generally, liquid crystal materials having high molecular weights have high viscosity. Therefore, the response speed of the liquid crystal layer using such a liquid crystal material is slower. However, the liquid crystal layer LC of this embodiment is a liquid crystal layer formed of the polymer dispersed liquid crystal material. In the liquid crystal layer LC of the polymer dispersed liquid crystal material, the liquid crystal molecules MC are dispersed in the gaps (which may as well be referred to as micro regions or droplets) of the polymer PM. With this configuration, the response speed of the liquid crystal molecules MC is high. Therefore, even when liquid crystal molecules MC of a liquid crystal material having high molecular weight are used, the response speed of the liquid crystal layer LC of the display panel PNL of this embodiment is sufficiently high. In this embodiment, it is possible to obtain a display panel PNL (display device DSP) with a sufficiently high response speed even when a liquid crystal material with large molecular weight, that is, a liquid crystal material having a transition temperature Tni of 120° C. or higher and 150° C. or lower, is used.

But, as the transition temperature Tni increases, the smectic-nematic transition temperature (which will be referred to as a transition temperature Tsn) increases as well. When the temperature of the liquid crystal material becomes the transition temperature Tsn or lower, the liquid crystal material shifts to a smectic phase. In the display panel PNL of this embodiment, when the liquid crystal molecules MC in the liquid crystal layer LC shift to a smectic phase, there is a risk that they may not be driven.

As to this point, when the transition temperature Tni of the liquid crystal material in the liquid crystal layer LC of this embodiment is 120° C. or higher and 150° C. or less, the transition temperature Tsn of the liquid crystal material will not become excessively high.

Therefore, according to the above-described embodiment, it is possible to obtain a display device and its manufacturing method in which non-uniformity in display do not occur. Thus, the display device DSP (display panel PNL) of this embodiment does not cause non-uniformity in display, and therefore it is possible to improve the display quality.

### Configuration Example 1

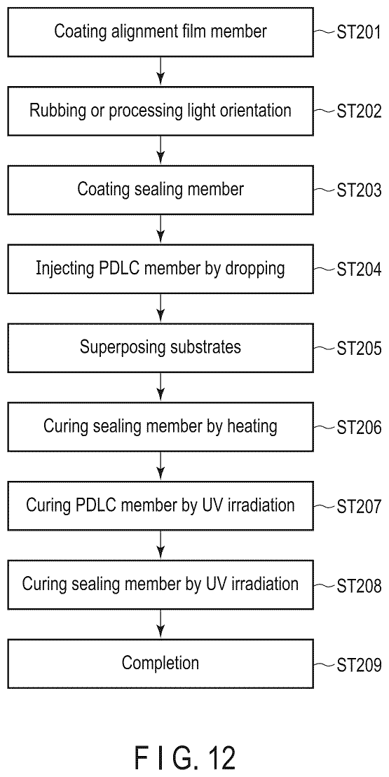

FIG. 12 is a flowchart of another configuration example of the display device in the embodiment. The configuration example shown in FIG. 12 is different from the example shown in FIG. 11 in that the curing process for the sealing member SAL by heating and the curing process by UV irradiation are reversed in order.

In this configuration example, the process of step ST101 to step ST105 are similar to that of the above-described embodiment (see FIG. 11). In this configuration example, steps ST201 to ST205 are carried out as a process similar to that of the steps ST101 to ST105 of the embodiment.

After superposing the substrate SUB2 on the substrate SUB1 (step ST205), the thermosetting resin of the sealing member SAL is cured by heating (Step ST206: Curing the sealing member by heating). Thus, the thermosetting resin contained in the sealing member SAL is cured. The temperature Tc, which is the heating temperature in step ST206, is lower than the transition temperature Tni, as in the case of the embodiment.

Note that in step ST206, the photocurable resin may as well be cured by heating. That is, when a thermal radical agent is added to the photocurable resin, the photocurable resin as well is cured by heat. The curing of the photocurable resin by heat may occur in the entirety or only a part of the photocurable resin.

Next, the polymer dispersed liquid crystal (PDLC) member is cured by UV irradiation (Step ST207: Curing the PDLC member by UV irradiation). In this step, the liquid crystalline monomers are polymerized in a manner similar to that of the embodiment provided above.

The photocurable resin of the sealing member SAL is cured by UV irradiation (Step ST208: Curing the sealing member by UV irradiation). Thus, the photocurable resin contained in the sealing member SAL is cured. When a part of the photocurable resin is cured by heat, the entire photocurable resin is cured by step ST208.

As described above, the display panel PNL (display device DSP) is completed (Step ST209: (Completion).

In this configuration example, advantageous effects similar to those of the embodiment are achieved.

In this disclosure, the substrate SUB1 and the substrate SUB2 may as well be referred to as a first substrate and a second substrate, respectively. Further, the liquid crystal layer LC containing a polymer dispersed liquid crystal material may as well be referred to as a polymer dispersed liquid crystal layer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate including a plurality of switching elements;
a second substrate disposed to oppose the first substrate;
a sealing member disposed between the first substrate and the second substrate; and
a polymer dispersed liquid crystal layer containing a polymer and liquid crystal molecules, and disposed between the first substrate and the second substrate and in a region surrounded by the sealing member, wherein
the polymer dispersed liquid crystal layer has a nematic-isotropic transition temperature higher than a curing temperature of the sealing member.

2. The display device according to claim 1, wherein
the nematic-isotropic transition temperature of the polymer dispersed liquid crystal layer is 120° C. or higher and 150° C. or lower.

3. The display device according to claim 1, further comprising:
a plurality of pixels containing the plurality of switching elements, respectively; and
a display area comprising the plurality of pixels, wherein
the sealing member is disposed arranged around the display area.

4. The display device according to claim 1, wherein
the liquid crystal molecules of the polymer dispersed liquid crystal layer include tricyclic compounds having three six-membered rings or tetracyclic compounds having four six-membered rings.

5. A method of manufacturing a display device, comprising:
forming a first substrate by forming a plurality of switching elements on a first base,
forming a sealing member so as to surround a display area including the plurality of switching elements;
dropping a polymer dispersed liquid crystal material containing a liquid crystal material containing liquid crystal molecules and liquid crystal monomers onto a region surrounded by the sealing member;
disposing a second substrate to oppose the first substrate;
curing the sealing member by irradiating ultraviolet light thereon; and
forming a polymer by irradiating ultraviolet light onto the liquid crystal monomers to polymerize; and
curing the sealing member cured by irradiation of the ultraviolet light, by heating the sealing member, wherein
the polymer dispersed liquid crystal material has a nematic-isotropic transition temperature higher than a curing temperature of the sealing member by heating.

6. The method according to claim 5, wherein
the nematic-isotropic transition temperature of the polymer dispersed liquid crystal material is 120° C. or higher and 150° C. or lower.

7. The method according to claim 5, wherein
the display device comprises:
a plurality of pixels containing the plurality of switching elements, respectively; and
a display area comprising the plurality of pixels, and
the sealing member is disposed to surround the display area.

8. The method according to claim 5, wherein
the liquid crystal molecules of the polymer dispersed liquid crystal material contain tricyclic compounds having three six-membered rings or tetracyclic compounds having four six-membered rings.

9. A method of manufacturing a display device, comprising:
forming a first substrate by forming a plurality of switching elements on a first base,
forming a sealing member so as to surround a display area including the plurality of switching elements;
dropping a polymer dispersed liquid crystal material containing a liquid crystal material containing liquid crystal molecules and liquid crystal monomers onto a region surrounded by the sealing member;
disposing a second substrate to oppose the first substrate;
curing the sealing member by heating the sealing member;
forming a polymer by irradiating ultraviolet light onto the liquid crystal monomers to polymerize; and
curing the sealing member cured by the heating by irradiation ultraviolet light thereon, wherein
the polymer dispersed liquid crystal material has a nematic-isotropic transition temperature higher than a curing temperature of the sealing member by heating.

10. The method according to claim 9, wherein
the nematic-isotropic transition temperature of the polymer dispersed liquid crystal material is 120° C. or higher and 150° C. or lower.

11. The method according to claim 9, wherein
the display device comprises:
a plurality of pixels containing the plurality of switching elements, respectively; and
a display area comprising the plurality of pixels, and
the sealing member is disposed to surround the display area.

12. The method according to claim 9, wherein
the liquid crystal molecules of the polymer dispersed liquid crystal material contain tricyclic compounds having three six-membered rings or tetracyclic compounds having four six-membered rings.
